(19) United States
(12) Patent Application Publication
(10) Pub. No.: US 2013/0260001 A1
(43) Pub. Date: Oct. 3, 2013

(54) LIQUID CREAMERS AND METHODS OF MAKING SAME

(71) Applicants: Alexander A. Sher, Dublin, OH (US); Christine Ann Beeson, Marysville, OH (US); Winnie Octavia, Delaware, OH (US); Antonio J. Gutierrez, Dublin, OH (US)

(72) Inventors: Alexander A. Sher, Dublin, OH (US); Christine Ann Beeson, Marysville, OH (US); Winnie Octavia, Delaware, OH (US); Antonio J. Gutierrez, Dublin, OH (US)

(21) Appl. No.: 13/990,689

(22) PCT Filed: Nov. 23, 2011
(86) PCT No.: PCT/EP2011/070750

§ 371 Date: May 30, 2013

Related U.S. Application Data
(60) Provisional application No. 61/418,239, filed on Nov. 30, 2010.

(51) Int. Cl. A23C 11/02

(52) U.S. Cl. CPC A23C 11/02
USPC 426/540; 426/601; 426/417

(57) ABSTRACT

Liquid creamers and methods of making the liquid creamers are provided. In a general embodiment, the present disclosure provides a liquid creamer including 1) a colorant, 2) an oil, 3) a hydrocolloid stabilizing system including a cellulose component and a gum component in an amount sufficient to suspend the colorant, and 4) an emulsifying stabilizing system including emulsifier(s) and a protein in an amount sufficient to maintain emulsion stability in the liquid creamer. The gum component can include kappa carrageenan and iota carrageenan having a kappa carrageenan:iota carrageenan weight ratio of about 3:1 to about 1:10. The weight ratio among the cellulose component, the gum component, the emulsifier and the protein can be about 1:(0.005-8):(0.05-20):(0.025-5), respectively.

### BACKGROUND

The present disclosure generally relates to food products. More specifically, the present disclosure is directed to liquid creamers for food products such as coffee and tea.

Creamers are widely used as whitening agents with hot and cold beverages such as, for example, coffee, cocoa, tea, etc. They are commonly used in place of milk and/or dairy cream. Creamers may come in a variety of different flavors and provide mouthfeel, body, and a smoother texture.

Creamers can be in liquid or powder forms. One disadvantage of powder forms is that they do not generally provide an impression of traditional dairy creamers. Another disadvantage of using powder creamers may include difficulties in dissolution when added to coffee, and also the possibility of having a non-homogeneous beverage.

Fresh or refrigerated dairy, liquid whiteners usually provide good mouthfeel. However, they are unacceptable for people with dairy intolerance. They are also inconvenient to use due to short storage capabilities. Moreover, liquid dairy creamers deteriorate rapidly even under refrigeration conditions.

The market of non-dairy creamers as coffee whiteners is rapidly growing, and the U.S. is the market leader for this type of product. A desired creamer should be shelf-stable during storage without phase separation, creaming, gelation and sedimentation. The creamer should also retain a constant viscosity over time. When added to cold or hot beverages such a coffee or tea, the creamer should dissolve rapidly, provide a good whitening capacity, and remain stable with no feathering and/or sedimentation while providing a superior taste.

Current consumer trends demonstrate increased consumption of reduced-fat and fat-free products, including creamers. However, fat provides a whitening quality, and the removal thereof requires an increase in whitening capability of the creamer. This can be achieved by the addition of a whitening component or colorant, but it is difficult to maintain the whitening component in solution. Therefore, it is difficult to provide low-fat creamers without diminishing their whitening capacity as compared to conventional full-fat creamers, and further without compromising stability. Fat also provides flavor and body to creamers, so it is a further challenge to prepare a low-fat creamer that maintains the same satisfaction as a full-fat creamer.

It is well known that emulsions and suspensions are not thermodynamically stable, and there is a real challenge to overcome physico-chemical instability issues in the liquid creamers that contain oil and other insoluble materials, especially for the aseptic liquid creamers during long storage times and at elevated temperatures. Moreover, over time, creaming that can still be invisible in the liquid beverages stored at room and elevated temperatures can cause a plug in the bottle when refrigerated. Other issues include feathering and other beverage destabilization when creamer is added to a beverage, especially in a hot, acidic, high calcium and/or magnesium iron environment.

In view of the previous discussion, there are numerous challenges in creating a homogeneous, aseptic, shelf-stable, liquid creamer without broken emulsion (especially plug formation when the beverage product is kept at least overnight after storage at ambient conditions) and sedimentation for low-fat, liquid creamers due to the relatively low viscosity required for these type of creamers. Therefore, there is a need for aseptic, shelf-stable, low-fat, liquid creamers with high whitening capacity, good physico-chemical stability, constant overtime viscosity and pleasant mouthfeel. The desired low-fat, liquid creamers, when added to beverages such as hot coffee, tea, etc., should provide a good mouthfeel without feathering, flocculation, sedimentation and other phase separation issues.

### SUMMARY

The present disclosure relates to liquid creamers for food products and methods of making the liquid creamers. The liquid creamers can be shelf-stable and aseptic. The liquid creamers can be low-fat and have high whitening capacity and a pleasant mouthfeel. The liquid creamers can maintain good physico-chemical properties, especially emulsion and suspension stability at manageable viscosity without phase separation (e.g., creaming, sedimentation, age gelation) during different storage conditions over the full life of the liquid creamer.

In a general embodiment, the present disclosure provides a liquid creamer including 1) a colorant, 2) an oil, 3) a hydrocolloid stabilizing system including a cellulose component and a gum component, and 4) an emulsifying stabilizing system including emulsifier(s) and a protein. The gum component includes kappa carrageenan and iota carrageenan having a kappa carrageenan: iota carrageenan weight ratio of about 3:1 to about 1:10. The weight ratio among the cellulose component, the gum component, the emulsifier(s) and the protein is about 1:(0.005-8):(0.05-20):(0.025-50), respectively. The liquid creamer can be a low-fat, liquid creamer.

In any embodiments of the liquid creamer described herein, the liquid creamer can be maintained in a homogeneous state for at least about 9 months at 20° C., 3 months at 30° C. and/or 1 months at 38° C. The colorant can be titanium dioxide present in an amount of about 0.05% to about 1% by weight of the liquid creamer.

In any embodiments of the liquid creamer described herein, the cellulose component can include a cellulose blend of two different cellulose compounds. The cellulose component can range from about 0.1% to about 2.0% by weight of the liquid creamer.

In any embodiments of the liquid creamer described herein, the cellulose component can include a cellulose blend of microcrystalline cellulose (“MCC”) and carboxymethyl cellulose (“CMC”). The cellulose blend can include carboxymethyl cellulose ranging from about 25% to about 90% by weight of the cellulose blend.

In any embodiments of the liquid creamer described herein, the gum component can be present in an amount ranging from about 0.01% to about 0.8% by weight of the liquid creamer. The gum component can further include lambda carrageenan.

In any embodiments of the liquid creamer described herein, the emulsifiers can include one or more low molecular weight emulsifiers ranging from about 0.01% to about 2.0% by weight of the liquid creamer. The emulsifiers can be include, but are not limited to, monoglycerides, succinic acid esters of monoglycerides, diacetyl tartaric acid esters of monoglycerides, polysorbate, sodium stearoyl lactylate or a combination thereof.

In any embodiments of the liquid creamer described herein, the protein can range from about 0.05% to about 5% by weight of the liquid creamer. The protein can be one or more of casein, sodium caseinate, potassium caseinate, calcium caseinate, soy protein, pea protein, whey protein, wheat protein, egg whites or a combination thereof.

In any embodiments of the liquid creamer described herein, the oil can include about 0.5% to about 3% by weight of vegetable oil. The oil can be a vegetable oil such as soybean oil, coconut oil, palm oil, palm oil fractions, cotton seed oil, canola oil, olive oil, sunflower oil, high oleic sunflower oil, safflower oil or a combination thereof.

In any embodiments of the liquid creamer described herein, the liquid creamer can further include one or more additional ingredients such as flavors, sweeteners or a combination thereof.

In another embodiment, the present disclosure provides a stable, low-fat, liquid creamer including 1) a colorant, 2) an oil, 3) a buffering agent in amount ranging from about 0.1% to about 1.0% by weight of the liquid creamer, 4) a hydrocolloid stabilizing system including a cellulose component and a gum component, and 5) an emulsifying stabilizing system including emulsifier(s) and a protein. The gum component includes kappa carrageenan and iota carrageenan having a kappa carrageenan:iota carrageenan weight ratio of about 3:1 to about 1:10. The weight ratio among the cellulose component, the gum component, the emulsifier(s) and the protein is about 1:(0.005-8):(0.05-20):(0.025-50), respectively.

In any embodiments of the liquid creamer described herein, the buffering agent can be one or more of sodium mono-and di-phosphates, potassium mono-and di-phosphates, sodium mono- and bi-carbonates, potassium mono- and bi-carbonates or a combination thereof.

In an alternative embodiment, the present disclosure provides a method of making a stable liquid creamer. The method comprises hydrating a combination of 1) a colorant, 2) an oil, 3) a hydrocolloid stabilizing system including a cellulose component and a gum component, wherein the gum component includes kappa carrageenan and iota carrageenan having a kappa carrageenan:iota carrageenan weight ratio of about 3:1 to about 1:10, and 4) an emulsifying stabilizing system including emulsifier(s) and a protein, wherein the weight ratio among the cellulose component, the gum component, the emulsifier(s) and the protein is about 1:(0.005-8):(0.05-20):(0.025-50), respectively, to form a liquid creamer. The method further comprises homogenizing the liquid creamer and aseptically filling a container with the liquid creamer.

In an embodiment, the method comprises heat treating the liquid creamer before filling the container. The method can also comprise adding a buffering agent in amount ranging from about 0.1% to about 1.0% by weight to the liquid creamer before homogenizing the liquid creamer. The buffering agent can include, but is not limited to, sodium mono-and di-phosphates, potassium mono-and di-phosphates, sodium mono- and bi-carbonates, potassium mono- and bi-carbonates or a combination thereof.

An advantage of the present disclosure to provide an improved low-fat, liquid creamer.

Another advantage of the present disclosure is to provide a low-fat, liquid creamer having a high whitening capacity.

Still another advantage of the present disclosure is to provide a shelf-stable liquid creamer that maintains a manageable viscosity over an extended storage time.

Yet another advantage of the present disclosure is to provide a liquid creamer that does not have stability issues such as de-oiling, flocculation, feathering and/or sedimentation during storage and when added to beverage at high temperature.

Another advantage of the present disclosure is to provide a liquid creamer that has a good mouthfeel, body, smooth texture and a good flavor without off-notes.

Additional features and advantages are described herein, and will be apparent from, the following Detailed Description.

### DETAILED DESCRIPTION

The present disclosure relates to liquid creamers and methods of making the liquid creamers. The liquid creamer can be added to any suitable beverage in an amount sufficient to provide a creaming effect to the beverage. A creaming effect imparts qualities associated with cream or dairy such as desirable, flavor, texture, body, and/or color (e.g., lightening or whitening). In alternative embodiments, the liquid creamers are stable and overcome phase separation issues (e.g., creaming, plugging, gelation, syneresis, sedimentation, etc.) during storage at refrigeration temperatures (e.g., ˜4° C.), room temperatures (e.g., ˜20° C.) and elevated temperatures (e.g., ˜30 to 38° C.). The stable liquid creamers can have a shelf-life stability, for example, for at least 9 months at 20° C., 6 months at 30° C., and 1 month at 38° C.

The low-fat, liquid creamers in embodiments of the present disclosure can be formed by the interaction of oil(s)/fats, protein(s), carbohydrate(s), colorant(s) and, optionally, flavor(s), and stabilized by the use of complex systems containing the combinations of emulsifier(s) and hydrocolloid(s). It has been surprisingly found that a specific combination of a cellulose component, a gum component, an emulsifier and a protein at specific ranges and weight ratios significantly improved the physico-chemical stability of low-fat, liquid creamers. For example, the specific combinations of these components provide stable, low-fat, liquid creamers with good emulsion stability and manageable viscosity without phase separation during different storage conditions over an extended period of time. In addition, the unique combination of the stabilizing systems was advantageously and unexpectedly found to provide the creamers with a high whitening ability and to provide a resulting beverage having the added liquid creamer with a good mouthfeel, lighter color, a smooth texture and a pleasant, refreshing taste.

As used herein, the term “stable” means remaining in a state or condition having minimal phase separation (e.g., creaming, sedimentation, age gelation) for an extended period of time (e.g., for at least 1 month). Stable liquid creamers according to embodiments of the present disclosure can be found to be stable when maintained for at least 1 month, and are generally stable from 2 to 3 months or longer without feathering, flocculation, sedimentation issues.

In a general embodiment, the present disclosure provides a liquid creamer including 1) one or more colorants, 2) one or more oils, 3) a hydrocolloid stabilizing system including one or more cellulose components and one or more gum components in an amount sufficient to suspend the colorant, and 4) an emulsifying stabilizing system including one or more emulsifiers and one or more proteins in an amount sufficient to maintain emulsion stability in the liquid creamer. The gum component can include kappa carrageenan and iota carrageenan having a kappa carrageenan:iota carrageenan weight ratio of about 3:1 to about 1:10.

It was advantageously and unexpectedly found that the developed stabilizing systems provide a desired functionality with specific combinations of carrageenans, celluloses (e.g., a MCC/CMC blend), emulsifiers (e.g., a low molecular weight emulsifier), and proteins (e.g., sodium caseinate). In an embodiment, the advantageous weight ratio among the cellulose component, the gum component, the emulsifier and the protein is about 1:(0.005-8):(0.05-20):(0.025-50), respectively.

The hydrocolloid stabilizing system including the cellulose component and the gum component can stabilize the suspension of the colorant (e.g., whitening agent). The cellulose component and the gum component can further help stabilize the protein. The emulsifying stabilizing system can further help the emulsion stability of the colorant. The hydrocolloid stabilizing system and the emulsifying stabilizing system can further help stabilize the colorant in the liquid beverage to which the creamer is added.

In an embodiment, the liquid creamer is a low-fat, liquid creamer. The fat/oil content of the liquid creamer can range, for example, from about 0.5% to about 3% by weight of the liquid creamer. As used herein, the term “low-fat” means containing little fat or oil (e.g., less than 3%, 2%, 1%, etc. fat or oil) or no fat or oil at all. In an embodiment, the liquid creamer is maintained in a homogeneous state for at least about 9 months at 20° C., 9 months at 4° C., 3 months at 30° C. and 1 month at 38° C.

In an embodiment, the colorant can be a whitening agent in an amount sufficient to provide further whitening to an aqueous media to which the liquid creamer is added. For example, the whitening agent can be TiO₂, which can be present in an amount of about 0.05% to about 1% by weight of the liquid creamer. The TiO₂ can have a particle size ranging from about 0.1 to about 0.7 microns, with a preferred embodiment having a particle size of 0.4 microns. When TiO₂ is used as a complementary whitener, the TiO₂ can be maintained in full suspension throughout the liquid creamer shelf-life.

In another embodiment, the particulate size of the whitening agent ranges between 0.3 and 0.5 microns. The optimum size of the whitening agent is obtained when light scattering is delivering the most intense white color. This is related to the wavelength considered and for the whole visible spectrum the optimum size would be half the average wavelength or around 0.30 microns. It may be expected that a smaller size would make the liquid creamer itself bluish in color, whereas a larger size would progressively decrease the whitening power.

Using a particle size around a mean of 0.30 microns should be beneficial at least on two accounts. The increased whitening power results in less of the whitening component needed for the same end color, which allows for a cost reduction. The smaller particles are also easier to suspend and keep suspended. Generally speaking, suspended particles are governed by the Stokes' law terminal velocity in term of gravitational force providing a tendency for settling. However, at particle sizes lower than about 2.0 microns, other forces become significant and also control the settling or suspension. It is well known that below 2.0 microns Brownian motion predominates and the gravitational forces becomes less and less important as the size is reduced, thus favoring suspension of small particles without much settling.

In an embodiment, the cellulose component includes a cellulose blend of two different cellulose compounds and/or any other cellulose compounds known in the art. In an embodiment, the cellulose component includes a cellulose blend of microcrystalline cellulose and carboxymethyl cellulose. The cellulose blend can include carboxymethyl cellulose ranging from about 25% to about 90% by weight of the cellulose blend. The cellulose component can range from about 0.1% to about 2.0% by weight of the liquid creamer. In a preferred embodiment, the cellulose component ranges from about 0.2% to about 0.4% by weight of the liquid creamer.

In an embodiment, the gum component is present in an amount ranging from about 0.01% to about 0.8% by weight of the liquid creamer. In a preferred embodiment, the gum component ranges from about 0.05% to about 0.1% by weight of the liquid creamer. The gum component can further include lambda carrageenan. The gum component can also be any other suitable gum known to the skilled artisan.

The emulsifying stabilizing system can include combinations of proteins and low molecular weight emulsifiers at specified ratios. In an embodiment, the emulsifiers include low molecular weight emulsifiers ranging from about 0.1% to about 2.0% by weight of the liquid creamer. In a preferred embodiment, the emulsifiers range from about 0.2% to about 0.6% by weight of the liquid creamer. The emulsifiers can be one or more of monoglycerides, succinic acid esters of monoglycerides, diacetyl tartaric acid esters of monoglycerides, polysorbate, sodium stearoyl lactylate or a combination thereof

In another embodiment, the emulsifying stabilizing system can include a combination of at least two low molecular weight emulsifiers at specified weight ratios. The type of emulsion can be controlled by the emulsifiers, and the emulsifiers should be soluble in the continuous phase.

Low molecular weight emulsifiers can include, but are not limited to, monoglycerides, diglycerides, acetylated monoglycerides, sorbitan trioleate, glycerol dioleate, sorbitan tristearate, propyleneglycol monostearate, glycerol monooleate and monostearate, alone or in combination. Further, emulsifiers can include, but are not limited to, sorbitan monooleate, propylene glycol monolaurate, sorbitan monostearate, calcium stearoxyl-2-lactylate, glycerol sorbitan monopalmitate, soy lecithin, and diacetylated tartaric acid esters of monoglycerides, alone or in combination.

In an embodiment, the protein ranges from about 0.05% to about 5% by weight of the liquid creamer. In a preferred embodiment, the protein ranges from about 0.1% to about 0.6% by weight of the liquid creamer. The protein can be one or more of casein, sodium caseinate, potassium caseinate, calcium caseinate, soy protein, pea protein, whey protein, wheat protein, egg whites or a combination thereof.

In an embodiment, the oil includes about 0.5% to about 3% by weight of vegetable oil. The oil(s) can provide creaminess and mouthfeel to the creamer. The oils can also participate in the whitening effect of the creamer. The oil can be a vegetable oil such as, for example, soybean oil, coconut oil, palm oil, palm oil fractions, cotton seed oil, canola oil, olive oil, sunflower oil, high oleic sunflower oil, safflower oil or a combination thereof. The sunflower oil can be high oleic sunflower oil. The vegetable oil(s) can include partially or wholly hydrogenated oils, alone or in combination.

The oils can be blended in any suitable amount and manner to ensure maximum oxidation stability. For instance, the oil can include a blend of vegetable oils that comprises no more than 65% saturated fatty acids, and the blend of vegetable oils comprises no more than 1% trans fatty acids.

The oil can be the main component of the disperse phase in the form of an emulsion. In an embodiment, the average diameter of the oil droplets is lower than 0.6 microns. Preferably, the oil droplets have a diameter ranging from about 0.25 microns to 0.45 microns. The oil droplets of the emulsion in this range of particle size provide an optimal whitening effect.

In an embodiment, the liquid creamer further includes one or more additional ingredients such as flavors, sweeteners or a combination thereof. For example, for improved flavor acceptance, the liquid creamers can contain sweeteners including, but not limited to, natural sweeteners and/or artificial sweeteners or a combination thereof. More specifically, the sweeteners can include, for example, sucrose, fructose, dextrose, maltose, dextrin, levulose, tagatose, galactose, corn syrup solids and other natural or artificial sweeteners. Sugarless sweeteners can include, but are not limited to, sugar alcohols such maltitol, xylitol, sorbitol, erythritol, mannitol, isomalt, lactitol, hydrogenated starch hydrolysates, and the like, alone or in combination. Further, the liquid creamers can contain one or more flavors such as French vanilla, caramel, hazelnut, strawberry and/or other fruity flavors, alone or in combination.

The sweeteners may be present in an amount from about 0.1% to about 50% by weight, and in another embodiment, from about 5% to 35% by weight. Usage level of the flavors and sweeteners will vary greatly and will depend on such factors as potency of the sweetener, desired sweetness of the product, level and type of flavor used and cost considerations.

In another embodiment, the present disclosure provides a stable, low-fat, liquid creamer including 1) a colorant, 2) an oil, 3) a buffering agent in amount ranging from about 0.1% to about 1.0% by weight of the liquid creamer, 4) a hydrocolloid stabilizing system including a cellulose component and a gum component in an amount sufficient to suspend the colorant, and 5) an emulsifying stabilizing system including an emulsifier and a protein in an amount sufficient to maintain emulsion stability in the liquid creamer. The gum component can include kappa carrageenan and iota carrageenan having a kappa carrageenan:iota carrageenan weight ratio of about 3:1 to about 1:10. The weight ratio among the cellulose component, the gum component, the emulsifier and the protein can be about 1:(0.005-8):(0.05-20):(0.025-50), respectively.

The buffering agent can be used to prevent undesired creaming or precipitation of the liquid creamer upon addition into a hot, acidic environment such as coffee. The buffering agent can be, for example, sodium mono-and di-phosphates, potassium mono-and di-phosphates, sodium mono- and bi-carbonates, potassium mono- and bi-carbonates or a combination thereof. More specifically, non-limiting examples of suitable buffers are salts such as potassium phosphate, dipotassium phosphate, potassium hydrophosphate, sodium bicarbonate, sodium citrate, sodium phosphate, disodium phosphate, sodium hydrophosphate, and sodium tripolyphosphate. The buffer can be further present in an amount of about 0.5 to about 1% by weight of the liquid creamer.

The stable, low-fat, liquid creamers in embodiments of the present disclosure can be easily dispersible in coffee, stable in hot and cold acidic environments without feathering, breaking emulsion, de-oiling, flocculation and sedimentation. When added to coffee, tea, cocoa or other liquid products, the liquid creamers can provide a high whitening capacity, a good mouthfeel, full body, smooth texture, and also a good flavor with no off-flavor notes developed during storage time. The liquid creamers can be used with other various food products such as cereals, as cream for berries, creamers for soups and in many cooking applications.

In an alternative embodiment, the present disclosure provides a method of making a stable liquid creamer. The method comprises hydrating a combination of 1) a colorant, 2) an oil, 3) a hydrocolloid stabilizing system including a cellulose component and a gum component in an amount sufficient to suspend the colorant, wherein the gum component includes kappa carrageenan and iota carrageenan having a kappa carrageenan:iota carrageenan weight ratio of about 3:1 to about 1:10, and 4) an emulsifying stabilizing system including an emulsifier and a protein in an amount sufficient to maintain emulsion stability in the liquid creamer, wherein the weight ratio among the cellulose component, the gum component, the emulsifier and the protein is about 1:(0.005-8):(0.05-20):(0.025-50), respectively, to form a liquid creamer. The method further comprises homogenizing the liquid creamer and aseptically filling a container with the liquid creamer.

The hydration of gums, emulsifiers, proteins, buffers, sweeteners and/or flavors can be done in water (e.g., at 40° C. to 90° C.) under agitation with the addition of melted oil/fat, followed by heat treatment (e.g., sterilizing the mixture using a conventional ultra-high temperature (“UHT”) treatment), cooling and filling aseptic containers under aseptic conditions. Aseptic heat treatment may use direct or indirect UHT processes. UHT processes are known in the art. Examples of UHT processes include UHT sterilization and UHT pasteurization.

Direct heat treatment can be performed by injecting steam water in the emulsion. In this case, it may be necessary to remove excess water, for example, by flashing. Indirect heat treatment can be performed with a heat transfer interface in contact with the emulsion. The homogenization could be performed before and/or after heat treatment. It may be interesting to perform homogenization before heat treatment in order to improve heat transfers in the emulsion, and thus achieve an improved heat treatment. Performing a homogenization after heat treatment usually ensures that the oil droplets in the emulsion have the desired dimension. Aseptic filling is described in various publications, such as articles by L, Grimm in “Beverage Aseptic Cold Filling” (Fruit Processing, July 1998, p. 262-265), by R. Nicolas in “Aseptic Filling of UHT Dairy Products in HDPE Bottles” (Food Tech. Europe, March/April 1995, p. 52-58) or in U.S. Pat. No. 6,536,188 to Taggart, which are incorporated herein by reference.

In an embodiment, the method comprises heat treating the liquid creamer before filling the container. The method can also comprise adding a buffering agent in amount ranging from about 0.1% to about 1.0% by weight to the liquid creamer before homogenizing the liquid creamer. The buffering agent can be one or more of sodium mono- and di-phosphates, potassium mono-and di-phosphates, sodium mono- and bi-carbonates, potassium mono- and bi-carbonates or a combination thereof.

The aseptic liquid creamer, when added to a beverage, produces a physically stable, homogeneous, whitened drink with a good mouthfeel, and body, smooth texture, and a pleasant taste with no off-flavors notes. The use of the liquid creamers is not limited for only coffee applications. For example, the creamers can be also used for other beverages, such as tea or cocoa, or used with cereals or berries, creamers for soups, and in many cooking applications, etc.

To summarize, the liquid creamers in embodiments can overcome phase separation issues (e.g., creaming, plugging, gelation, syneresis, sedimentation, etc.) during storage at refrigeration (˜4° C.), room (e.g., 20 and 25° C.) and elevated temperatures (e.g., 30 and 38° C.). The liquid creamers can have a shelf-life stability for at least 9 months at 4° C. and 20° C., 3 months at 30° C. and 1 month at 38° C. The liquid creamers can provide a high whitening capacity and maintain a manageable viscosity over storage time. When added to hot, high acidic, high calcium/magnesium containing beverages, the liquid creamers do not have physico-chemical instability issues such as de-oiling, flocculation, feathering and/or sedimentation, but provide a good mouthfeel, body, smooth texture, and a good flavor without off-notes, itself and when added to a beverage such as, for example, coffee or tea.

### EXAMPLES

By way of example and not limitation, the following examples are illustrative of various embodiments of the present disclosure.

### Example 1

A dry blend of kappa- and iota-carrageenans with sucrose was prepared by mixing together 5000 g of sucrose with 10 g of the carrageenan (1:1 ratio) and 20 g of cellulose compound. The dry blend was added into 58 kg of hot water (˜75° C.) under high agitation. 500 g of di-potassium phosphate was then added to the tank under continuous agitation.

Next, a dry blend of other powder ingredients was prepared by mixing together 1000 g of sodium caseinate, 300 g of titanium dioxide, and 300 g of flavors. The dry blend was added to the tank of hot water with above stabilizers under high agitation. After ˜10 minutes of mixing, emulsifiers (50 g of Dimodan and 150 g of Panodan) were added into the tank under continuous high agitation. Further, 2 kg of oil (melted at ˜60° C.) was added under high agitation, followed by 25 kg of sucrose. Small amount of additional water was added to adjust the total product amount to 100 kg.

The liquid creamer was pre-heated, UHT treated for 5 sec at 143° C., homogenized at 180/40 bar and cooled. The liquid creamer was aseptically filled into bottles. The resultant liquid creamer can be aseptically filled in any aseptic containers such as, for example, jars, jugs or pouches. The liquid creamer was stored 1 month at 38° C., 3 months at 30° C. and 9 months at room temperature.

The physico-chemical stability and sensory of creamer and coffee beverages with added liquid creamer were judged by non-trained panelists. No phase separation (creaming, de-oiling, marbling, etc), gelation, and practically no viscosity changes were found during the storage.

It was surprisingly found that the liquid creamer has good appearance, mouth-feel, smooth texture and a good flavor without “off” taste. In addition, the creamer showed high whitening capacity when added to a coffee.

### Example 2

A dry blend of kappa- and iota-carrageenan with sucrose was prepared by mixing together 5000 g of sucrose with 20 g of the carrageenan (1:2 ratio) and 20 g of cellulose compound. The dry blend was added into 58 kg of hot water (˜75° C.) under high agitation. 500 g of di-potassium phosphate was then added to the tank under continuous agitation.

Next, a dry blend of other powder ingredients was prepared by mixing together 500 g of sodium caseinate, 300 g of titanium dioxide, and 300 g of flavors. The dry blend was added to the tank of hot water with above stabilizers under high agitation. After ˜10 minutes of mixing, emulsifiers (200 g of Dimodan and 200 g of Panodan) were added into the tank under continuous high agitation. Further, 2 kg of oil (melted at ˜60° C.) was added under high agitation, followed by 25 kg of sucrose. A small amount of additional water was added to adjust the total product amount to 100 kg.

The liquid was pre-heated, UHT treated for 5 sec at 143° C., homogenized at 180/40 bar and cooled. The liquid creamer was aseptically filled into bottles. The resultant liquid creamer can be aseptically filled in any aseptic containers such as, for example, jars, jugs or pouches. The liquid creamer was stored 1 month at 38° C., 3 months at 30° C. and 9 months at room temperature.

The physico-chemical stability and sensory of creamer and coffee beverages with added liquid creamer were judged by non-trained panelists. No phase separation (creaming, de-oiling, marbling, etc), gelation, and practically no viscosity changes were found during the storage.

It was surprisingly found that the liquid creamer has good appearance, mouth-feel, smooth texture and a good flavor without “off” taste. Further, the creamer showed high whitening capacity when added to a coffee.

### Example 3

A coffee whitener was prepared as in Example 1 but using 180 g of kappa-carrageenan and iota carrageenan (1:10 ratio). The physico-chemical stability and sensory of liquid creamer and coffee beverages with added liquid creamer were judged by non-trained panelists. After 2-months storage at 30° C., the sensory evaluation showed severe gelation in the bottle.

### Example 4

A coffee whitener was prepared as in Example 1 but using 500 g of the emulsifier. The physico-chemical stability and sensory of liquid creamer and coffee beverages with added liquid creamer were judged by non-trained panelists. After 3-months storage at 20° C., the sensory evaluation showed creaming in the bottle.

### Example 5

A coffee whitener was prepared as in Example 1 but using 260 g of sodium caseinate. The physico-chemical stability and sensory of liquid creamer and coffee beverages with added liquid creamer were judged by non-trained panelists. After 3-months storage at 20° C., the sensory evaluation showed significant creaming and flocculation in the bottle. When added to coffee, a significant decrease of whitening capacity as compared to the fresh made liquid creamer was observed.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A liquid creamer comprising:
a colorant;
an oil;
a hydrocolloid stabilizing system comprising a cellulose component and a gum component in an amount sufficient to suspend the colorant, the gum component comprises kappa carrageenan and iota carrageenan having a kappa carrageenan:iota carrageenan weight ratio of about 3:1 to about 1:10; and
an emulsifying stabilizing system comprising an emulsifier and a protein in an amount sufficient to maintain emulsion stability in the liquid creamer, the weight ratio of the cellulose component, the gum component, the emulsifier and the protein is about 1:(0.005-8):(0.05-20 ):(0.025-50), respectively.

2. The liquid creamer of claim 1, wherein the liquid creamer is a low-fat, liquid creamer.

3. The liquid creamer of claim 1, wherein the liquid creamer maintains a homogeneous state for at least about 9 months at 4° C. and 20° C., 3 months at 30° C. and 1 months at 38° C.

4. The liquid creamer of claim 1, wherein the colorant comprises titanium dioxide present in an amount of about 0.05% to about 1% by weight of the liquid creamer.

5. The liquid creamer of claim 1, wherein the cellulose component comprises a cellulose blend of two different cellulose compounds.

6. The liquid creamer of claim 1, wherein the cellulose component comprises about 0.1% to about 2.0% by weight of the liquid creamer.

7. The liquid creamer of claim 1, wherein the cellulose component comprises a cellulose blend of microcrystalline cellulose and carboxymethyl cellulose.

8. The liquid creamer of claim 1, wherein the cellulose blend comprises carboxymethyl cellulose comprising about 25% to about 90% by weight of the cellulose blend.

9. The liquid creamer of claim 1, wherein the gum component comprises about 0.01% to about 0.8% by weight of the liquid creamer.

10. The liquid creamer of claim 1, wherein the gum component further comprises lambda carrageenan.

11. The liquid creamer of claim 1, wherein the emulsifier comprises a low molecular weight emulsifier comprising about 0.1% to about 2.0% by weight of the liquid creamer.

12. The liquid creamer of claim 1, wherein the emulsifier is selected from the group consisting of monoglycerides, succinic acid esters of monoglycerides, diacetyl tartaric acid esters of monoglycerides, polysorbate, sodium stearoyl lactylate and combinations thereof.

13. The liquid creamer of claim 1, wherein the protein comprises about 0.05% to about 5% by weight of the liquid creamer.

14. The liquid creamer of claim 1, wherein the protein is selected from the group consisting of casein, sodium caseinate, potassium caseinate, calcium caseinate, soy protein, pea protein, whey protein, wheat protein, egg whites and combinations thereof.

15. The liquid creamer of claim 1, wherein the oil comprises about 0.5% to about 3% by weight of vegetable oil.

16. The liquid creamer of claim 1, wherein the oil comprises a vegetable oil selected from the group consisting of soybean oil, coconut oil, palm oil, palm oil fractions, cotton seed oil, canola oil, olive oil, sunflower oil, high oleic sunflower oil, safflower oil and combinations thereof.

17. The liquid creamer of claim 1 further comprising an ingredient selected from the group consisting of flavors, sweeteners and combinations thereof.

18. A stable, low-fat, liquid creamer comprising:
a colorant;
an oil;
a buffering agent comprising about 0.1% to about 1.0% by weight of the liquid creamer;
a hydrocolloid stabilizing system comprising a cellulose component and a gum component in an amount sufficient to suspend the colorant, the gum component comprises kappa carrageenan and iota carrageenan having a kappa carrageenan:iota carrageenan weight ratio of about 3:1 to about 1:10; and
an emulsifying stabilizing system comprising an emulsifier and a protein in an amount sufficient to maintain emulsion stability in the liquid creamer, the weight ratio of the cellulose component, the gum component, the emulsifier and the protein is about 1:(0.005-8):(0.05-20):(0.025-50), respectively.

19. The stable, low-fat, liquid creamer of claim 18, wherein the buffering agent is selected from the group consisting of sodium mono-and di-phosphates, potassium mono-and di-phosphates, sodium mono- and bi-carbonates, potassium mono- and bi-carbonates and combinations thereof.

20. A method of making a stable liquid creamer, the method comprising:
hydrating a combination of: a colorant; an oil; a hydrocolloid stabilizing system comprising a cellulose component and a gum component in an amount sufficient to suspend the colorant, the gum component comprises kappa carrageenan and iota carrageenan having a kappa carrageenan:iota carrageenan weight ratio of about 3:1 to about 1:10; and an emulsifying stabilizing system comprising an emulsifier and a protein in an amount sufficient to maintain emulsion stability in the liquid creamer, the weight ratio of the cellulose component, the gum component, the emulsifier and the protein is about 1:(0.005-8):(0.05-20):(0.025-50), respectively, to form a liquid creamer;
homogenizing the liquid creamer; and
aseptically filling a container with the liquid creamer.

21. The method of claim 20 comprising heat treating the liquid creamer before filling the container.

22. The method of claim 20 comprising adding a buffering agent in amount of about 0.1% to about 1.0% by weight to the liquid creamer before homogenizing the liquid creamer.

23. The method of claim 22, wherein the buffering agent is selected from the group consisting of sodium mono-and di-phosphates, potassium mono-and di-phosphates, sodium mono- and bi-carbonates, potassium mono- and bi-carbonates and combinations thereof.
